(19) United States
(12) Patent Application Publication
(10) Pub. No.: US 2016/0169633 A1
(43) Pub. Date: Jun. 16, 2016

(54) ARMOR, SHIELDS AND HELMETS WITH HIGHLY PROPERTY-MISMATCHED INTERFACE MATERIALS TO REDUCE DYNAMIC FORCE AND DAMAGE

(71) Applicant: Luoyu Roy XU, El Paso, TX (US)

(72) Inventor: Luoyu Roy XU, El Paso, TX (US)

(21) Appl. No.: 14/960,846

(22) Filed: Dec. 7, 2015

Related U.S. Application Data
(60) Provisional application No. 62/090,331, filed on Dec. 10, 2014.

(51) Int. Cl. F41H 5/04; B32B 7/02; B32B 25/20; B32B 27/28; B32B 27/34; B32B 5/12; F41H 1/02; B32B 27/36

(52) U.S. Cl. CPC F41H 5/04; F41H 1/02; B32B 7/02; B32B 27/365; B32B 27/36; B32B 27/28; B32B 27/34; B32B 5/12; B32B 25/20; B32B 2571/02

(57) ABSTRACT

Armor/shields/helmets including highly property-mismatched interfaces (mismatch level of bulk materials and interfaces more than 60%) are disclosed, which provide protections against external dynamic loading such as blast loading, impact of projectiles and sharp-edged foreign objects. The mechanism to reduce dynamic force and damage is a specific material design using soft and ductile interfaces/adhesive layers to 1) bond or hold other layers/bulk materials with blast/impact/stab resistance, 2) reduce stress wave transmission and the maximum dynamic force, 3) decrease shear deformation of the inner layers behind interfaces, and 4) dissipate more energy due to blast and impact along the armor/shield/helmet surface. Therefore, less energy would be available to contribute to penetrate the armor/shields/helmets, or cause damage.

### BACKGROUND OF THE INVENTION

1. Field of the Invention

The present invention relates to a material system for armor, shields and helmets including highly property-mismatched interface layers to reduce dynamic damage and impact force caused by external dynamic loading such as blast and impact.

2. Description of Related Art

Armor, shield and helmet systems often employ single materials such as steel or polycarbonate, or hybrid materials such as combined ceramics and fibrous composites. Between different materials and layers, interface materials such as adhesive layers are often employed.

### SUMMARY

An interface usually refers to a surface forming a common boundary between adjacent regions, bodies, substances, or phases. As used in this disclosure, the term interface refers to a surface or a layer between one or two kinds of materials and can transfer some kinds of force, for example, compressive force. The interface may have zero thickness or a small but non-zero thickness, such as a thin adhesive layer to bond two kinds of materials together. Prior major efforts to design armor, shields and helmets are focused on the selections of blast-, impact- or stab-resistant materials and layouts, and very little effort was focused on designing interfaces to enhance overall blast-, impact- and stab-resistance. A purpose of this invention is to provide new armor, shield and helmet designs using special interfaces, such that more external energy is dissipated and dynamic damage is reduced. For brevity, in this disclosure, armor, shield, helmet etc. are collectively referred to as personal protection devices, or simply “shields”, but it should be understood that they can take various physical format. The material may also be used in vehicles. Further, the term “impact” is used to refer to various types of impacts such as from blast, projectiles, other sharp-edged foreign object such as knives, etc.

Conventional shield systems often employ single materials such as steel or polycarbonate, or hybrid materials such as combined ceramics and fibrous composites. Between different materials and layers, interface materials such as adhesive layers are often employed. Embodiments of the current invention provide effective interface designs, such that the interface not only provides basic functions such as adhesion, but also increases energy dissipation, and reduces damage to the shield. Even for homogenous armor materials such as polycarbonate and Plexiglas, their dynamic mechanical performance is significantly improved if specific interfaces are embedded inside these hard polymers. The technology in this invention (interface designs) is more efficient than the existing technology (hybrid material designs). The shields are suitable for use by military personnel, police and civilians such as football players, students and travelers. The benefits for the users include multiple protections for their bodies to heads at reasonable prices.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a layered structure for use in personal protection device or vehicles, which includes: a first layer made of a first material; a second layer made of a second material, the second layer being an outer layer subjected to external loading; and a third layer made of a third material, wherein the first layer is located between the second and third layers and in contact with the second and third layers, wherein an impedance mismatch between the first and second materials is greater than 60%, the impedance mismatch being defined as IM=(P−1)/(P+1), where P is an impedance ratio defined as P=\sqrt{ρ_{B}E_{B}/(ρ_{A}E_{A})}, where E_{A} is a Young's modulus of the first material, E_{B} is a Young's modulus of the second material, ρ_{A} is a density of the first material, and ρ_{B} is a density of the second material.

In another aspect, the present invention provides a layered structure for use in personal protection device, which includes: a first layer made of a first material; a second layer made of a second material; and a third layer made of a third material, wherein the first layer is located between the second and third layers and in contact with the second and third layers, wherein a shear modulus mismatch between the first and second materials is greater than 60%, the shear modulus mismatch being defined as

$$SM = \frac{{μ}_{B} - {μ}_{A}}{{μ}_{B} + {μ}_{A}} = \frac{{E}_{B} ( 1 + {v}_{A} ) - {E}_{A} ( 1 + {v}_{B} )}{{E}_{B} ( 1 + {v}_{A} ) + {E}_{A} ( 1 + {v}_{B} )}$$

where μ_{A} is a shear modulus of the first material, μ_{B} is a shear modulus of the second material, E_{A} is a Young's modulus of the first material, E_{B} is a Young's modulus of the second material, ν_{A} is a Poisson ratio of the first material, and ν_{B} is a Poisson ratio of the second material.

It is to be understood that both the foregoing general description and the following detailed description are exemplary and explanatory and are intended to provide further explanation of the invention as claimed.

### BRIEF DESCRIPTION OF THE DRAWINGS

FIG. 1A shows a shield material according to an embodiment of the present invention, which has multiple interfaces, against knife impact.

FIG. 1B shows a cross-sectional view of the shield unit with multiple layers which employs three materials.

FIG. 2A shows a cross-sectional view of the shield unit subjected to projectile impact.

FIG. 2B shows another cross-sectional view of the shield unit subjected to projectile impact.

FIG. 3A shows a cross-sectional view of the shield unit subjected to projectile impact where the path is perpendicular to the interface surface.

FIG. 3B shows a cross-sectional view of the shield unit subjected to projectile impact along a typical inclined path with an incident angle θ.

FIG. 4 shows a cross-sectional view of the shield unit with different projectile paths to illustrate the working principle of the shield.

FIG. 5A shows a cross-sectional view of a shield unit with several straight interfaces according to another embodiment of the present invention.

FIG. 5B shows a cross-sectional view of a shield unit with several inclined interface layers with respect to the surface of the shield according to another embodiment of the present invention.

FIG. 5C shows a cross-sectional view of a shield unit with symmetrical inclined interface layers according to another embodiment of the present invention.

FIG. 5D shows a cross-sectional view of a shield unit with several curved interface layers according to another embodiment of the present invention.

FIG. 6A shows a plate with two bonded armor layers using a thin adhesive layer according to another embodiment of the present invention.

FIG. 6B shows a square plate with two bonded armor layers using an adhesive layer according to another embodiment of the present invention.

FIG. 6C shows a plate with three bonded armor layers using two thin adhesive layers according to another embodiment of the present invention.

FIG. 7A shows an impacted polymer plate with two adhesive layers and impact damage inside the outer layer only.

FIG. 7B shows another impacted polymer plate with two adhesive layers and impact damage inside the outer layer only.

FIG. 8A shows a shield including 30-layer Kevlar fabrics with an interface layer between the 12th and 13th layers according to another embodiment of the present invention.

FIG. 8B shows disassembled layers of the shield of FIG. 8A after being shot by two bullets.

FIG. 9A shows two units of a shield of embodiments of the present invention which may be folded.

FIG. 9B shows two folded shield units forming a temporary helmet to protect a person's head against sharp projectile.

### DETAILED DESCRIPTION OF PREFERRED EMBODIMENTS

FIG. 1A shows a representative element of a shield 1 according to an embodiment of the present invention, which has multiple layers, against impact from a projectile or sharp object 2 (a knife is shown in this illustration). Although the shape of a shield may be a circular shape or polygon, more typically it is a rectangular shape and its length and width are determined by practical applications. If the shield is used as an insert of a backpack, its typical size may be 250 mm*300 mm (or 10 inch*12 inch). The shield can have a large curvature if it is used as a helmet to protect a person's head. For illustration purposes, a flat shield unit is shown in this disclosure. If the shield is used in military or police helmets, external dynamic loading often refers to blast loading, and impact loading caused by bullets, and fragmentations. If the shield is used in sport helmets, motorcycles helmets or other helmets to protect civilians, foreign objects which lead to impact loading acting on helmets often refer to ground or hard objects on ground, and helmets of other players.

Typically, impact loading on the shield leads to two kinds of results: 1) pure elastic deformation or no damage if the kinetic or chemical energy of the impact is low, such as collision of two football helmets. However, brain damage such as concussion may still occur even there is no damage in helmets. 2) plastic deformation and damage if the impact energy is high such as when a military helmet is hit by a fast and sharp fragmentation. For case 1), key protection objectives are to limit the maximum impact force and reduce shear deformation, and for case 2), key protection objectives are to stop penetration and minimize back-face deformation.

FIG. 1B shows a cross-sectional view of the shield element, with multiple layers which include several materials. Material A (layer 3) is an adhesive with desired properties as will be described later, which forms an interface layer in contact with the other layers. Material B (layer 4) and Material C (layer 5) provide impact resistance. The shield has at least two layers to form at least one interface, or more than two layers depending on the armor materials (materials B and C) and threat levels.

Typical adhesive material A includes silicon, polyurethane, and other adhesives satisfying property mismatch levels to be described later. Typical materials B and C include polycarbonate and polyethylene, layered fabric made of high tensile strength fibers, such as aramid fibers or polyethylene fibers, ceramics, and metals. Materials B and C may be the same material or different materials. Material B is the material used for the outer layer 4 which is directly subjected to dynamic loading. Material C is used for the inner layer 5 which faces the person or vehicles being protected.

The protection capability for the shield is mainly determined by the impact-resistance materials B and C, their thicknesses, and the interface designs. For example, if only the aramid (Kevlar-type) fabric is employed to meet the US National Institute of Justice (NIT) level IIIA protection, the total thickness of the aramid fabric layers (material B and material C) should be at least 6 mm.

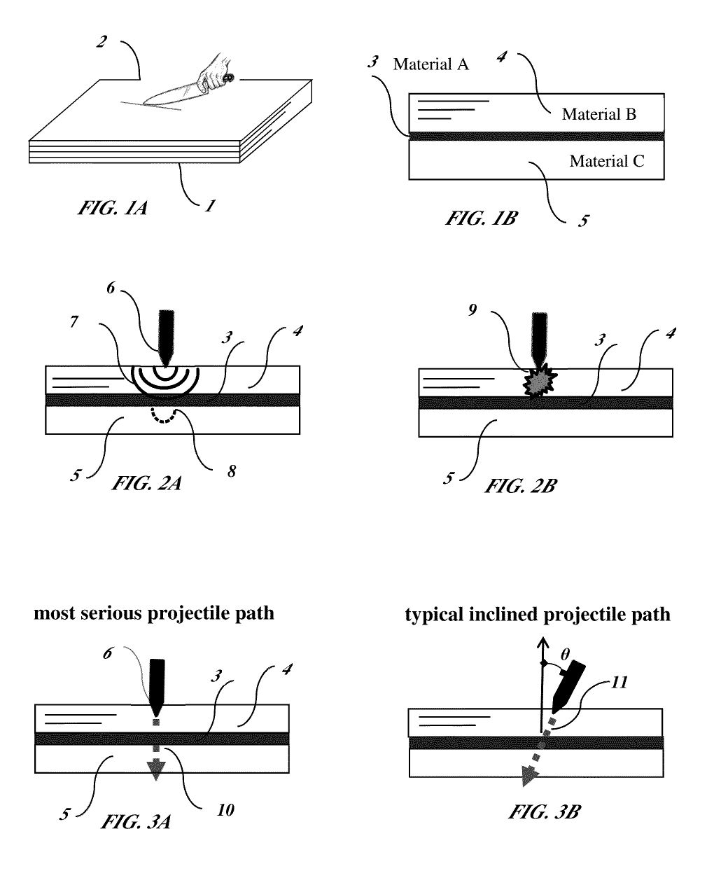

A main feature of this embodiment of the invention is to design and select interfacial materials A to increase the capability of the shield without altering the impact-resistance materials B and C. FIG. 2A shows a cross-sectional view of the shield unit subjected to projectile impact 6. The projectile 6 may be a bullet (as illustrated in FIG. 2A), a knife, etc. The outer layer 4 (i.e., the layer that faces the projectile) has more stress wave 7, and the inner layer 5 (i.e., the layer that is behind the interface layer) has much less stress wave 8.

One-dimensional stress wave modeling shows that a small amount of the incident stress wave is transmitted into the inner layer, due to the dramatic reduction of the impedance (product of the material density and the sound wave speed of the material) of the interface material A. The ratio of the transmitted stress in the inner layer over the incident stress in the outer layer after reflection at two material boundaries between material B/A, and A/C can be expressed as (Eq. (1))

$$λ = \frac{4 \sqrt{{ρ}_{C} {E}_{C} / ( {ρ}_{A} {E}_{A} )}}{( 1 + \sqrt{{ρ}_{C} {E}_{C} / ( {ρ}_{A} {E}_{A} )} ) ( 1 + \sqrt{{ρ}_{B} {E}_{B} / ( {ρ}_{A} {E}_{A} )} )}$$

where E and ρ are Young's modulus and density (or specific gravity) of the respective materials. If materials B and C are the same material, an impedance ratio may be defined as P=\sqrt{ρ_{B}E_{B}/(ρ_{A}E_{A})}, and an impedance mismatch of two materials may be defined as IM=(P−1)/(P+1). Table 1 shows these values for some material combinations based on impact experiments conducted by the inventor of this invention.

For the first two material combinations shown in Table 1, their mismatches in impedances are low (less than 35%). As a result, their ratios of the transmitted stress are quite high, and the adhesive layer did not have any protection for the inner layer. For the rest of the material combinations shown in Table 1, their mismatches in impedances all exceed 94%, and their ratios of the transmitted stress are very low (less than 11%). Therefore, four material combinations, Loctite 5083 adhesive/polymer Homalite, Loctite 5083/Plexiglas, Loctite 5083/Polycarbonate, silicone-rubber/Kevlar fabrics all showed effective protection to their inner layers. These are examples of material combinations that can be used to form the shield unit of the present embodiment.

Loctite-330, 384 and 5083 are adhesive materials manufactured by Henkel Corp., Rocky Hill, Conn., USA. Homalite-100 is thermosetting polyester material manufactured by Homalite™ Division, Brandywine Investment Group, Corp., Wilmington, Del., USA. Plexiglas is a tradename for poly(methyl methacrylate) (PMMA). Kevlar is the registered trademark for a para-aramid synthetic fiber developed DuPont. Silicone-rubber is an elastomer (rubber-like material) composed of silicone containing silicon together with carbon, hydrogen, and oxygen, and can be used as an adhesive.

TABLE 1
Performance comparisons and property mismatches of selected adhesive bonds

| | | transmitted | impedance | Shear modulus | Protection |
|---|---|---|---|---|---|
| Interface | Bonding | stress | mismatch | mismatch | for the |
| material A | material B | ratio λ | IM | SM | inner layer |
| Loctite 384 | Homalite-100 | 100% | 0% | 9.57% | No |
| Loctite 330 | Homalite-100 | 88.9% | 34.3% | 56.5% | No |
| Loctite 5083 | Homalite-100 | 8.8% | 95.5% | 98.9% | Yes |
| Loctite 5083 | Plexiglas | 8.6% | 95.6% | 99.9% | Yes |
| Loctite 5083 | Poly-carbonate | 10.6% | 94.6% | 98.9% | Yes |
| Silicone-rubber | Kevlar Fabric | 5.9% | 97.1% | 99.9% | Yes |

Generally, it is preferred that less than 50%, more preferably less than 10% stress wave is transmitted into the inner layer, so the impedance of material B should be at least 6 times (for λ<50%), preferably 38 times (for λ<10%) the impedance of material A (adhesive). In terms of the impedance mismatch IM of the two bonded materials A and B, the recommended high impedance mismatch is from 60% to 99%, preferably 80% to 99%. Furthermore, if the densities of material B and the adhesive A are the same, the stress wave inside the inner layer will be smaller than the stress wave inside the outer layer, if the Young's modulus of material B is more than 34 times (for λ<50%), preferably 1,444 times (for λ<10%) that of material A. No absolute material property needs to be listed here, because the performance of each material combination is mainly determined by the relative material properties (non-dimensional) of the two bonded materials. For typical shields including acetoxy silicon as material A and hard polymers as material B, the stress wave transmission rate λ may be less than 11% as shown in Table 1. As a result, FIG. 2B shows that the outer layer has impact damage 9, but the inner layer has no damage due to less stress wave transmitted, and other mechanisms such as the high shear modulus mismatch. In order to ensure stress wave reflection at two interfaces, the minimum thickness of the interface (material A) should be 10 μm. There is no maximum thickness for the interface layer except for practical limitations.

In order to evaluate the static material property mismatch of hybrid materials, two Dundurs parameters α and β, which are two non-dimensional parameters computed from the elastic constants of the two bonded materials, can be expressed as follows (Eqs. (2) and (3)),

$$α = \frac{{μ}_{A} {m}_{B} - {μ}_{B} {m}_{A}}{{μ}_{A} {m}_{B} + {μ}_{B} {m}_{A}} = \frac{{E}_{A} - {E}_{B}}{{E}_{A} + {E}_{B}}$$

$$β = \frac{{μ}_{A} ( {m}_{B} - 2 ) - {μ}_{B} ( {m}_{A} - 2 )}{{μ}_{A} {m}_{B} + {μ}_{B} {m}_{A}}$$

where μ_{A} is the shear modulus of material A, μ_{B} is the shear modulus of material B, m=4(1−ν) for plane strain deformation, ν is the Poisson ratio, and m=4/(1+ν) for plane stress deformation. The two parameters α and β represent the Young's modulus mismatch and the bulk modulus mismatch of the two bonded materials. They are key static parameters for interfacial stress distributions and fracture. For the current interfacial dynamic mechanics, the impedance mismatch of the two materials as expressed in equation (1) and Table 1 becomes more important to design shields. In equations (2) and (3), the shear modulus is included, but its role in the shield design has not been explored before.

FIG. 3A shows a cross-sectional view of the shield unit subjected to projectile impact 6 and its path 10 is perpendicular to the interface surface. The arrow 10 indicates a path for the projectile 6 that would convert its maximum kinetic energy along the shortest distance (perpendicular to the shield's surface), such that the target behind the shield will be hit quickly. On the other hand, in order to defeat the projectile, the new shield design of this embodiment needs to alter the projectile path, so the projectile travels along a longer path to dissipate more kinetic energy, and has less energy for target penetration.

FIG. 3B shows a typical projectile path 11 with an inclined direction with respect to the shield surface for typical projectile impact cases. A projectile incident angle θ is defined as the angle between the norm of the shield surface and the projectile path right before it contacts the outer layer. A similar parameter is the incident angle between the norm of the adhesive (interface) layer and the projectile path right before it contacts the adhesive layer. If the adhesive layer is parallel to the shield surface, these two angles are the same. In this embodiment, the projectile incident angle only refers to the incident angle respect to the adhesive layer.

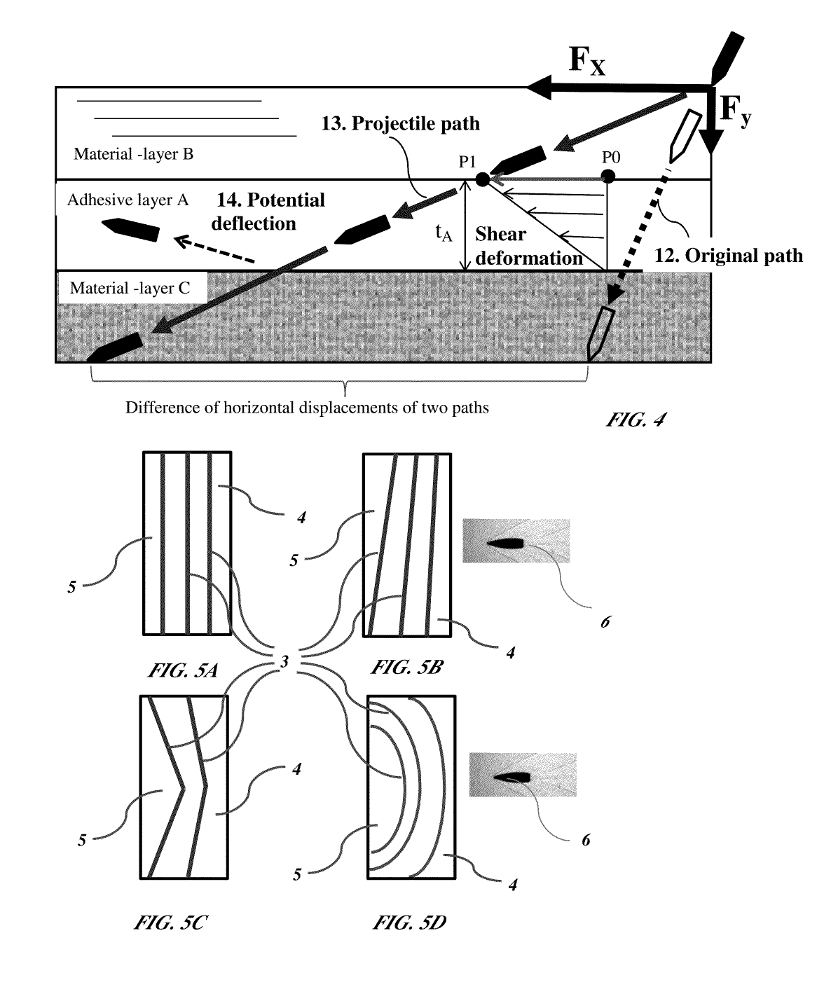

FIG. 4 shows a cross-sectional view of a layered shield unit with two potential projectile paths. This illustration only shows the horizontal deformation, not the complete deformation including the vertical deformation. To avoid overcrowding, the cross-section in FIG. 4 only illustrates a part of a larger shield.

The original path 12 indicates the projectile path inside a pure homogenous armor material such as steel or other layered hybrid materials without the interface layer of this embodiment (i.e., the embedded highly property-mismatched interface layers). When the interface layer is present, due to the impact force component F_{X} acting on the outer layer along the shield surface (X direction), the outer layer has a horizontal displacement with respect to the inner layer through the interface or adhesive layer, which dissipates some kinetic energy of the projectile. The embodiments of the present invention make use of this mechanism to achieve a more effective shield.

This mechanism is analogous to a boat's movement in a pond. If a stone hits the boat with an inclined angle with respect to the horizontal pond surface, the vertical impact force component F_{Y} tends to sink the boat (analogous to penetration to the shield). But the horizontal impact force component F_{X} tends to slide the boat. If the stone is inside the boat, its kinetic energy will be dissipated more along the pond surface, less along the vertical direction to sink the boat.

For the present impact scenarios, when the projectile just contacts or is inside the outer layer, the vertical impact force component F_{Y} acting on the outer layer will be transferred to the adhesive layer across the interface through the interfacial normal (compressive) stress. The interface layer will have a vertical displacement downward, so the projectile dissipates energy due to the vertical displacement (energy dissipation equals to the product of force and its moving distance). The maximum vertical displacement of the external layer without penetration is the total thickness of the interface layer, if we assume the layer under the interface layer is a fixed rigid substrate.

The key mechanism of this invention is that the horizontal displacement of the interface layer can be much larger than the interface layer thickness. In FIG. 4, the horizontal impact force component F_{X} acting on the outer layer will be transferred to the interface layer through the interfacial shear stress. As a result, the adhesive layer (interface layer) has a horizontal displacement. As illustrated in FIG. 4 on the horizontal displacement of the interface, an original point P0 at the interface will move to P1 due to the shear deformation of the interface layer. The interfacial shear stress τ may be expressed by the shear modulus of the interface layer μ_{A} and the shear strain γ (Eq. (4)):

τ=μ_{A}γ

Therefore, reducing the shear modulus of the interface will increase the shear strain or deformation if the shear stress is fixed. Such a mechanism requires that material A has a very small shear modulus (which is proportional to the Young's modulus), and very large shear failure strain. For example, the shear modulus of the adhesive is less than 0.1 GPa, or less than 10% of the shear modulus of the material adjacent to the adhesive layer (i.e. material B). Then, the distance between points P0 and P1 can be much larger than the thickness of the adhesive layer t_{A}.

Finally the projectile stops inside the shield as shown in FIG. 4. The difference of two maximum horizontal displacements of the original projectile path 12 and the new path 13 is a key parameter for energy dissipation. The displacement difference is due to the projectile path rotation (angle change) and the increased path length (length change) compared to the original projectile path 12, and can be expressed as a function including several parameters (Eq. (5)):

δ=δ(μ_{A},γ_{A},t_{A} . . . )

where γ_{A} is the maximum shear strain (related to the angle change) and t_{A} is the interface layer thickness (related to the length change). In order to ensure the above shear deformation mechanism, a low shear modulus of the interface layer is a key. This is analogous to a boat's movement in a pond again. A boat (similar to an outer layer) hit by a stone can move more along the horizontal direction if the boat is on water (low shear modulus) than on mud (high shear modulus). Here “low shear modulus” refers to a relatively low shear modulus (non-dimensional) compared to the shear moduli of the materials adjacent to the interface layer (i.e. material B), rather than an absolute low shear modulus. Therefore, a new parameter for interface dynamics, the shear modulus mismatch SM of two materials A and B can be expressed as fellows (Eq. (6)),

$$SM = \frac{{μ}_{B} - {μ}_{A}}{{μ}_{B} + {μ}_{A}} = \frac{{E}_{B} ( 1 + {v}_{A} ) - {E}_{A} ( 1 + {v}_{B} )}{{E}_{B} ( 1 + {v}_{A} ) + {E}_{A} ( 1 + {v}_{B} )}$$

Compared to the Young's modulus mismatch as shown in equation (2), the shear modulus mismatch includes the Poisson's ratios, therefore, it can be used to characterize more complicated phenomena. If the shear modulus of the interface layer (material A) is much smaller than that of material B (armor material), the shear modulus mismatch can be close to 100%. The shear modulus mismatch of some selected material combinations are listed in Table 1. When the shear modulus mismatch was less than 60%, no protection of the adhesive layer (e.g., Loctite adhesive 330 and 384) to the inner Homalite-100 brittle polymer layers was found during the impact process. The material design according to embodiments of the present invention requires that the shear modulus mismatch of the adhesive (A) and the armor material (B) be from 60% to 99%, preferably 80% to 99%. For the other material combinations shown in Table 1, the shear modulus mismatches all exceed 97%, therefore, protection of the adhesive (interface layer) to the inner layers was effective.

In FIG. 4, if the projectile incident angle is very large, when the projectile approaches the next layer, it may be deflected off its path as indicated by the arrow 14 and will not penetrate the shield. Compared to the original path 12 in conventional material systems, the current interface design dissipates more kinetic energy along the shield surface. As a result, the kinetic energy flow which is perpendicular to the shield surface will be reduced. Hence, the projectile is prevented from penetrating the shield, or the total thickness of the shield system can be reduced.

The above mechanisms can be employed in interfacial designs for new shields. The energy dissipation of the projectile is related to the increased horizontal displacement, or is an increasing function of the total interface layer thickness. Therefore, for this purpose, the interface layer should be as thick as possible. However, increasing the interface thickness may decrease the bonding strength and leads to other tradeoffs. One solution is to implement several thin interface layers rather than one thick interface layer 3, as shown in FIG. 5A. FIG. 5B is a shield cross-sectional view showing several inclined interface layers 3 with respect to the front surface of the shield, or the projectile 6 has a large incident angle with respect to the interface layers. Such a material design ensures that the horizontal impact force component F_{X} is large, and large shear deformation of the interface layer occurs more readily compared to the embodiment in FIG. 5A. Moreover, the multiple inclined interface design increases the possibility of projectile deflection at the last layer 5 because of 1) kinetic energy loss at the front layers 4, and 2) increased projectile incident angles with respect to the inner layers after multiple layer penetrations. FIG. 5C is an example of symmetrical inclined interface layers. FIG. 5D is an example of several symmetrical curved interface layers. The shield structures of FIGS. 5B to 5D require that at least the outer layer 4 has a non-uniform thickness. In the shield structures of FIGS. 5A to 5D, the layers of armor materials between the front layer 4 and the last layer 5 may be the same material as the front layer or the last layer or may be different materials than layers 4 and 5. The multiple interface layers 3 may use the same or different materials. The purpose of all above interfacial designs is to increase the projectile incident angle at every interface, such that the projectile dissipates more energy along the shield surface, and has less energy to penetrate the shield, or to reduce impact damage.

The various embodiments of the present invention are helpful to reduce back-face deformation of the shield also. Even the projectile is stopped, the large back-face deformation can cause serious injuries especially for heads. Generally, back-face deformation is an increasing function of the maximum impact force, a decreasing function of the bending stiffness of the shield (including a flat helmet unit) (bending stiffness increases as the in-plane Young's modulus and the shield thickness increase). Compared to a conventional shield unit, after one thin and soft interface layer is embedded in the present embodiment, the bending stiffness almost has no change. However, the through-thickness Young modulus along the impact direction (thickness direction) will be reduced based on micromechanics analysis, so the contact stiffness of the projectile and the target (the shield) reduces according to indentation mechanics theory. Under fixed impact energy of the projectile, reducing the contact stiffness will lead to reduced maximum impact force. Impact experiments conducted by the inventor (see examples below) supported this conclusion. Therefore, the maximum back-face deformation, which includes elastic, plastic and other permanent deformation, are reduced in shields constructed according to embodiments of the present invention.

The material properties of the layer behind the interface layer A (or the layer to be protected by the interface) is not critical and do not have to satisfy the mismatch conditions described here. As mentioned earlier, this material (e.g. material C and layer 5 in FIGS. 1B-4) may be the same as or different from material B. In a shield with multiple interface layers, the materials of each interface layer and the layer immediately before it should satisfy the mismatch conditions; the multiple interface layers may be the same or different materials, and the multiple armor layers immediately before each interface layer may be the same or different materials.

The manufacturing process for the shield is mainly determined by the specific interfaces to be chosen based on equations (1) and (6). For example, if acetoxy silicone is used as adhesive material A to bond polymeric materials B and C, the adhesive is applied to the whole bonding area, and pressure is applied on all layers in order to form a uniform adhesive layer under room temperature. Then, the shield unit is cured with ultraviolet light as recommended by the manufacturer of the adhesive. After ultraviolet light curing, the shield is left for several days in normal atmospheric condition to reach the full bonding strength.

### EXAMPLES

The following examples are based on impact experiments conducted by the inventor and showed effective protection of adhesive (interface) layers for the inner layers (reduced impact force and damage). Their materials property mismatches are listed in Table 1.

### Example 1

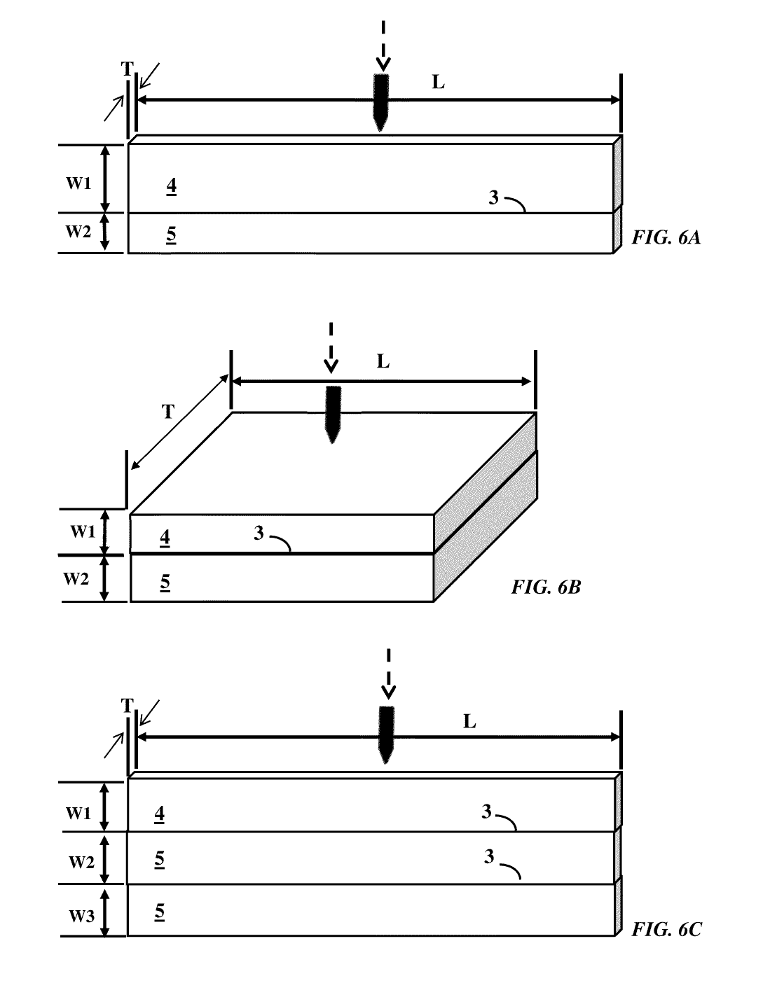

FIG. 6A shows a plate with two Homalite brittle polymer layers bonded by Loctite 5083 adhesive. Its length L=254 mm, out-of-plane thickness T=6.35 mm, widths of two layers W1=66 mm, W2=33 mm, the thickness of the adhesive layer was about 20 μm, and the projectile impact speed was 20 m/s and impact energy was 19 J. Impact damage was found in the outer layer 4 only.

### Example 2

In another experiment using the same plate as shown in FIG. 6A, the projectile impact speed was 21 m/s. Impact damage was found in the outer layer 4 only.

### Example 3

FIG. 6B shows a plate with two Polycarbonate layers bonded by Loctite 5083 adhesive. Its length L=T=127 mm, widths of two layers W1=W2=6.35 mm, the thickness of the adhesive layer was about 20 μm, and the impact energy ranged from 1 to 120 J. Polycarbonate with highly property-mismatched interfaces reduced the maximum impact force by 20% compared to bulk Polycarbonate subjected to the same impact conditions. If the maximum impact force was fixed at 12 KN, Polycarbonate with highly property-mismatched interfaces increased energy absorption by 130% compared to bulk Polycarbonate.

### Example 4

In another experiment using the same plate as shown in FIG. 6B except that the layers 4 and 5 are Plexiglas layers, impact energy ranged from 1 to 20 J. At impact energy of 20 J, Plexiglas with highly property-mismatched interfaces reduced the maximum impact force by 60% compared to bulk Plexiglas subjected to the same impact conditions.

### Example 5

FIG. 6C shows a plate with three Homalite layers bonded by Loctite 5083 adhesive. Its length L=254 mm, out-of-plane thickness T=6.35 mm, widths of three layers W1=W2=W3=33 mm, the thickness of the adhesive layer was about 20 μm, and the impact speeds were 20 m/s and 46 m/s. Impact damage was found in the external layer 4 only.

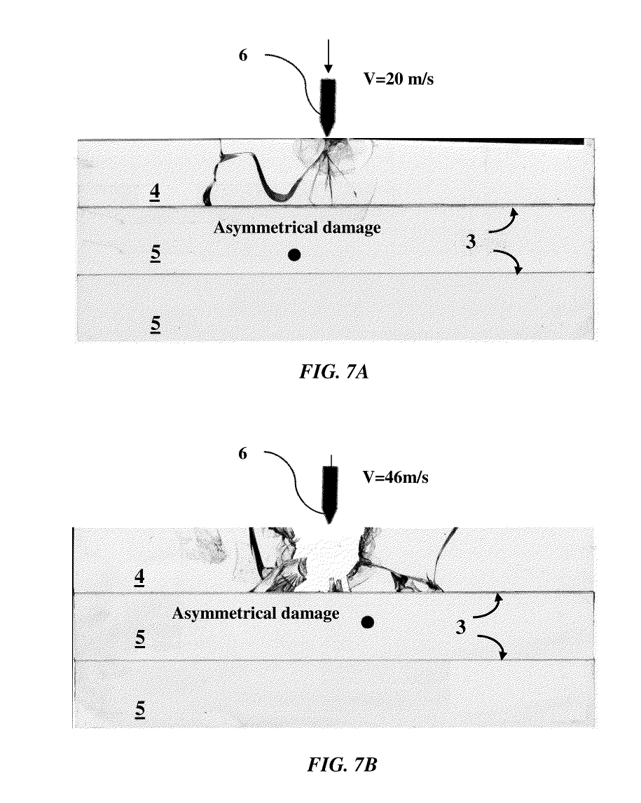

FIG. 7A shows a photo after an impact experiment of example #5 as illustrated in FIG. 6C. The projectile hit the top layer 4 and led to damage, but it was not able to penetrate the layered polymer (impact speed 20 m/s, impact energy 19 J). Asymmetrical damage pattern at the impact site indicates that the projectile hit the target with an incident angle.

FIG. 7B is another photo of the same specimen subjected to a high impact speed (46 m/s, impact energy 100 J). Asymmetrical damage pattern at the impact site indicates that the projectile hit the target with an incident angle. The above results support the multiply thin interfaces design as shown in FIG. 5A.

### Example 6

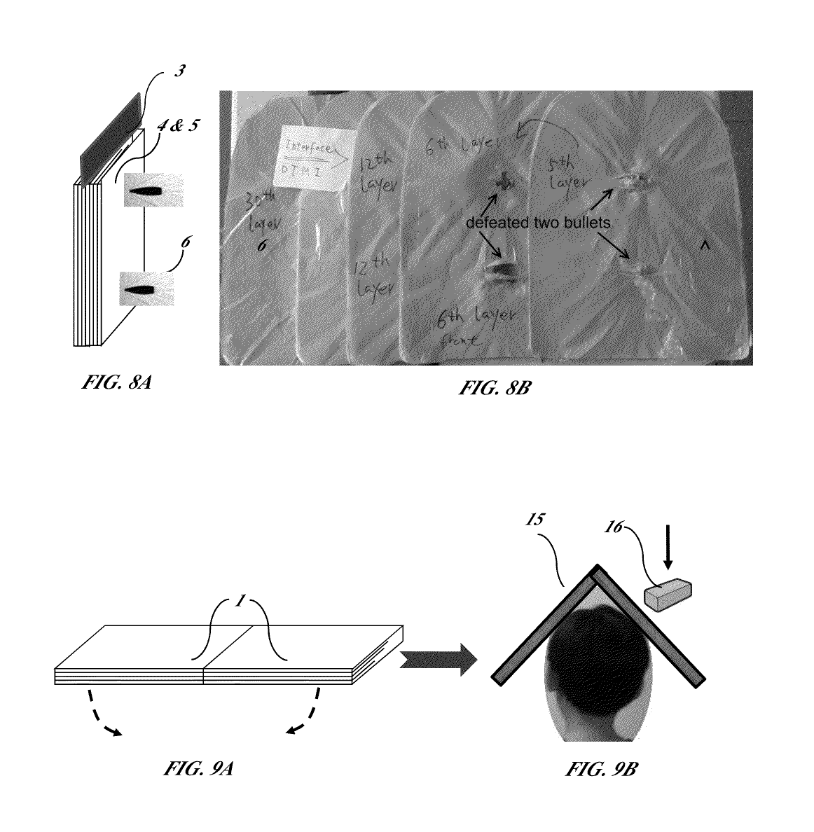

FIG. 8A shows an NIT level MA protection shield including 30-layer Kevlar fabrics with an embedded silicon interface between the 12th and 13th layers. This shield was shot by two 0.44 Magnum bullets.

FIG. 8B shows two bullets which were defeated into mushroom shapes between the 5th and 6th layers, or they were stopped much early before the 30th Kevlar layer due to the embedded interface.

In addition to the materials combination listed in Table 1, other materials combination may be used as material A and material B for constructing the shield, including: Loctite 5083 and glass-fiber laminates, polyurethane and alumina Al₂O₃, and Loctite 5083 and Aluminum. Other material combinations may be used, as long as they satisfy the property mismatch criteria described above. Material B may also be any other materials with ballistic or stab resistance properties.

If the shield is used to protect civilians, two shield units as shown in FIG. 9A can be folded into a temporary helmet 15 to protect a person's head against sharp projectiles 16 such as a falling brick as shown in FIG. 9B. The sizes of the total shield units and interfaces are determined by the protection requirements and materials employed.

It will be apparent to those skilled in the art that various modification and variations can be made in the personal protection device of the present invention without departing from the spirit or scope of the invention. Thus, it is intended that the present invention cover modifications and variations that come within the scope of the appended claims and their equivalents.

What is claimed is:

1. A layered structure for use in personal protection device or vehicles, comprising:
a first layer made of a first material;
a second layer made of a second material, the second layer being an outer layer subjected to external loading; and
a third layer made of a third material,
wherein the first layer is located between the second and third layers and in contact with the second and third layers,
wherein an impedance mismatch between the first and second materials is greater than 60%, the impedance mismatch being defined as IM=(P−1)/(P+1), where P is an impedance ratio defined as P=\sqrt{ρ_{B}E_{B}/(ρ_{A}E_{A})}, where E_{A} is a Young's modulus of the first material, E_{B} is a Young's modulus of the second material, ρ_{A} is a density of the first material, and ρ_{B} is a density of the second material.

2. The layered structure of claim 1, wherein the impedance mismatch between the first and second materials is greater than 80%.

3. The layered structure of claim 1, wherein the first layer is an adhesive that bonds the second and third layers together.

4. The layered structure of claim 1, wherein the second material and the third material are the same materials or different materials.

5. The layered structure of claim 4, wherein the second material is selected from Homalite-100, Plexiglas, polycarbonate and Kevlar fabric.

6. The layered structure of claim 5, wherein the first material is selected from Loctite 5083 and silicone-rubber.

7. The layered structure of claim 1, wherein the second layer has a non-uniform thickness.

8. The layered structure of claim 1, wherein the first layer has a curved shape.

9. The layered structure of claim 1, wherein a thickness of the first layer is greater than 10 μm.

10. The layered structure of claim 1, further comprising a fourth layer made of the first material and a fifth layer made of the third material.

11. A layered structure for use in personal protection device, comprising:
a first layer made of a first material;
a second layer made of a second material; and
a third layer made of a third material,
wherein the first layer is located between the second and third layers and in contact with the second and third layers,
wherein a shear modulus mismatch between the first and second materials is greater than 60%, the shear modulus mismatch being defined as
$$SM = \frac{{μ}_{B} - {μ}_{A}}{{μ}_{B} + {μ}_{A}} = \frac{{E}_{B} ( 1 + {v}_{A} ) - {E}_{A} ( 1 + {v}_{B} )}{{E}_{B} ( 1 + {v}_{A} ) + {E}_{A} ( 1 + {v}_{B} )}$$
where μ_{A} is a shear modulus of the first material, μ_{B} is a shear modulus of the second material, E_{A} is a Young's modulus of the first material, E_{B} is a Young's modulus of the second material, ν_{A} is a Poisson ratio of the first material, and ν_{B} is a Poisson ratio of the second material.

12. The layered structure of claim 11, wherein the shear modulus mismatch between the first and second materials is greater than 80%.

13. The layered structure of claim 11, wherein the first layer is an adhesive that bonds the second and third layers together.

14. The layered structure of claim 11, wherein the second material and the third material are the same materials.

15. The layered structure of claim 14, wherein the second material is selected from Homalite-100, Plexiglas, polycarbonate and Kevlar fabric.

16. The layered structure of claim 15, wherein the first material is selected from Loctite 5083 and silicone-rubber.

17. The layered structure of claim 11, wherein the second layer has a non-uniform thickness.

18. The layered structure of claim 11, wherein the first layer has a curved shape.

19. The layered structure of claim 11, wherein a thickness of the first layer is greater than 10 μm.

20. The layered structure of claim 11, further comprising a fourth layer made of the first material and a fifth layer made of the third material.
